(19) United States
(12) Patent Application Publication
(10) Pub. No.: US 2021/0239658 A1
(43) Pub. Date: Aug. 5, 2021

(54) HIGH-RESOLUTION LIQUID CHROMATOGRAPHY ON THE BASIS OF A SAWTOOTH GRADIENT

(71) Applicant: WACKER CHEMIE AG, Munich (DE)

(72) Inventors: Bernhard DURNER, Munich (DE); Thomas EHMANN, Kirchdorf (DE)

(73) Assignee: WACKER CHEMIE AG, Munich (DE)

(21) Appl. No.: 15/734,752

(22) PCT Filed: Jun. 6, 2018
(86) PCT No.: PCT/EP2018/064868

§ 371 Date: Dec. 3, 2020

(51) Int. Cl. G01N 30/34; G01N 30/88

(52) U.S. Cl. CPC G01N 30/34; G01N 2030/885; G01N 30/88

(57) ABSTRACT

Polymer makeup is analyzed by performing a liquid chromatographic analysis using a mobile phase containing at least one non-solvent S1 for the polymer and at least one solvent S2 for the polymer, wherein the volume proportion of the solvent S2 varies stepwise during the elution process, and the steps alternate between increasing and decreasing solvent content.

### CROSS REFERENCE TO RELATED APPLICATIONS

This application is the U.S. National Phase of PCT Appln. No. PCT/EP2018/064868 filed Jun. 6, 2018, the disclosure of which is incorporated in its entirety by reference herein.

### BACKGROUND OF THE INVENTION

### 1. Field of the Invention

The present invention relates to a method for analyzing a polymer sample, the method consisting of performing of a liquid chromatography analysis on a chromatography column with a mobile phase comprising a mixture of at least one nonsolvent (S1) and at least one solvent (S2) for the polymer sample, characterized in that the proportion by volume of S2 in the mobile phase is varied in a stepwise manner during the elution process and that the steps are alternately ascending and descending.

### 2. Description of the Related Art

IUPAC defines chromatography as follows: “Chromatography is a physical method of separation in which the components to be separated are distributed between two phases, one of which is stationary (stationary phase) while the other (the mobile phase) moves in a definite direction.”

In the case of liquid chromatography (LC), IUPAC says: “Liquid chromatography is a separation method in which the mobile phase is a liquid. Liquid chromatography can be carried out either in a column or on a plate.” Liquid chromatography includes separation methods such as SEC (size-exclusion chromatography), HPLC (high-pressure liquid chromatography), and IC (ion chromatography).

Liquid chromatography can be further subdivided according to the composition of the mobile phase into isocratic analysis and gradient analysis.

In isocratic analysis, the composition of the mobile phase remains constant throughout the elution process, whereas in gradient analysis the composition is varied continuously or in a stepwise manner.

Polymers are macromolecules formed from monomers. The sequential structure/individual repeat units and corresponding reaction methodology thus result in macromolecules that have distributions with respect to differing substance sizes. Depending on the chemical composition, distributions with respect to chemical functionality, molar mass or structure can arise. The polydispersity indicates, for example, how narrow or broad the molar mass distribution is.

Given the great industrial importance of polymers, in particular copolymers, modified polymers or polymer mixtures, an efficient method of separation based on chemical structure is of enormous interest. Because existing methods (e.g. size exclusion chromatography, SEC) often provide only average values, polymer HPLC based on gradient elution is currently the focus of intensive research.

HPLC methods of analysis for polymers by gradient analysis are known from the prior art. In particular, W. J. Staal (dissertation, Eindhoven University, 1996) provides a good overview of the origin and development of gradient-elution chromatography (GEC). A further overview is given in “Gradient HPLC of Copolymers and Chromatographic Cross-Fractionation” by Gottfried Glackner (Springer Verlag, 1991).

Although EP3170836A1 discloses an RP-HPLC (reverse phase) method of analysis with a step gradient, this is described for complex polypeptide mixtures such as glatiramer acetate or similar mixtures. In this method, the solvent/nonsolvent mixture is altered in a stepwise manner over time. In a particular embodiment, the less polar solvent is increased by 2-4% by volume every 4 to 6 minutes. The profile here thus resembles a step function.

Kajdan et al. (J. Chromatogr. A 1189 (2008) 183-195) disclose a two-dimensional gradient method with a zigzag-form gradient (“spike” gradient) for analyzing polypeptides. In this method, the composition of the mobile phase is maintained for a defined period of time before the original composition (100% mobile phase A) is restored. This gradient is however used for cation exchange in the first dimension, whereas in RP-LC (reversed-phase LC) a normal linear gradient is employed in the second dimension.

Spranger et al. (Environ. Sci. Technol. 2017, 51, 5061-5070) disclose a two-dimensional method of analysis for atmospheric HULIS (humic-like substances) that combines SEC (size-exclusion chromatography) in the one dimension and RP-HPLC in the other dimension. For RP-HPLC, a novel zigzag-form gradient (“spike” gradient) is employed in which the proportion of organic solvent in the mobile phase regularly increases, decreases, and remains constant.

The prior art does however have the following disadvantages:
persisting inadequacies in the separation of polymers, particularly with regard to oligomer resolution,
long elution times, or
methods not employable for polymers

There was therefore a need to provide a method for analyzing a polymer or polymer mixture that does not have these disadvantages.

### SUMMARY OF THE INVENTION

The object is achieved by a method for analyzing a polymer sample, the method consisting of the performance of a liquid chromatography analysis on a chromatography column with a mobile phase comprising a mixture of at least one nonsolvent (S1) and at least one solvent (S2) for the polymer sample, characterized in that the proportion by volume of S2 in the mobile phase is varied in a stepwise manner during the elution process and that the steps are alternately ascending and descending.

Surprisingly, it has now been found that a gradient with alternating ascending and descending steps, a so-called “sawtooth gradient”, achieves an improved separation effect in the case of polymers and polymer mixtures and is also able to separate high-molecular-weight polymers well.

### BRIEF DESCRIPTION OF THE DRAWINGS

FIGS. 1A-C show the schematic structure of a 2-dimensional step gradient (“sawtooth gradient”) in trapezoidal form (1A), in zigzag form (1B), and in columnar form (1C).

FIG. 2A shows a chromatogram of PVC measured with a linear gradient, FIG. 2B shows a chromatogram of PVC measured with a step gradient, and FIG. 2C shows a chromatogram of PVC measured with a sawtooth gradient in trapezoidal form (cf. Example 1).

FIG. 3A shows a chromatogram of PMMA measured with a linear gradient, FIG. 3B shows a chromatogram of PMMA measured with a sawtooth gradient in trapezoidal form (cf. Example 3).

FIG. 4A shows a chromatogram of PPG measured with a linear gradient, and FIG. 4B shows a chromatogram of PPG measured with a sawtooth gradient in trapezoidal form (cf. Example 3).

FIG. 5A shows a chromatogram of PDMS measured with a linear gradient, FIG. 5B shows a chromatogram of PDMS measured with a sawtooth gradient in trapezoidal form (cf. Example 3).

FIG. 6A shows a chromatogram of PMMA 690,000 measured as a 2-dimensional sawtooth gradient in trapezoidal form, FIG. 6B shows a chromatogram of PMMA 690,000 measured as a 3-dimensional sawtooth gradient in trapezoidal form (cf. Example 4).

FIG. 7 shows a chromatogram of a mixture of PDMS, PMMA, and PPG of similar average molar mass, measured with a sawtooth gradient in trapezoidal form (cf. Example 5).

### DETAILED DESCRIPTION OF THE PREFERRED EMBODIMENTS

The object of the present invention is a method for analyzing a polymer sample, the method consisting of the performance of a liquid chromatography analysis on a chromatography column with a mobile phase comprising a mixture of at least one nonsolvent (S1) and at least one solvent (S2) for the polymer sample, characterized in that the proportion by volume of S2 in the mobile phase is varied in a stepwise manner during the elution process and that the steps are alternately ascending and descending.

A polymer sample may for the purposes of the present invention be a polymer or a polymer mixture.

A polymer is for the purposes of the present invention to be understood as meaning a chemical substance that consists of repeat structural units and has an average molar mass within a range from a few thousand to several million g/mol; this encompasses both homopolymers and copolymers. Examples of such polymers are synthetic organic polymers such as polyvinyl chloride, polyethylene, polypropylene, polyvinyl acetate, polycarbonate, poly(meth)acrylate, polystyrene, polyacrylonitrile, polyvinylidene chloride, polyvinyl fluoride, polyvinylidene fluoride, polyvinylidene cyanide, polybutadiene, polyisoprene, polyethers, polyesters, polyamide, polyimide, polysiloxanes, polysilanes, polyvinyl alcohol, polyvinylpyrrolidone, polyacrylamide, polyethylene glycol, and derivatives and copolymers thereof, and natural polymers such as cellulose, starch, casein, and natural rubber, and also semisynthetic high-molecular-weight compounds such as cellulose derivatives, for example methylcellulose, hydroxymethyl cellulose, and carboxymethyl cellulose. A polymer mixture preferably contains at least two polymers from this group.

Poly(meth)acrylates are for the purposes of the present invention to be understood as meaning polyacrylates and polymethacrylates and also polyalkyl acrylates and polyalkyl methacrylates, alkyl being preferably a linear or branched C₁-C₂₀ hydrocarbon radical.

Examples of poly(meth)acrylates are polymethyl (meth)acrylates, polyethyl (meth)acrylates, polybutyl (meth)acrylates, and polyisobutyl (meth)acrylates.

Polysiloxanes are for the purposes of the present invention to be understood as meaning compounds of the general formula (I)

(SiO_{4/2})ₐ(R^{x}SiO_{3/2})_{b}(R^{x}₂SiO_{2/2})_{c}(R^{x}₃SiO_{1/2})_{d} (I),

where

R^{x} are independently hydrogen, unbranched, branched, acyclic or cyclic, saturated or mono- or polyunsaturated C₁-C₂₀ hydrocarbon radicals, the hydroxy radical, the vinyl radical, alkoxy radicals, amino groups, halogen or silyloxy radicals of the general formula (II)

(SiO_{4/2})ₑ(R^{y}SiO_{3/2})_{f}(R^{y}₂SiO_{2/2})_{g}(R^{y}₃SiO_{1/2})ₕ (II),

in which R^{y} are independently hydrogen, halogen, unbranched, branched, linear, acyclic or cyclic, saturated or multiply saturated C₁-C₂₀ hydrocarbon radicals, wherein individual carbon atoms may be replaced by oxygen, halogen, nitrogen or sulfur, and a, b, c, d, e, f, g, and h are each independently integers within a range from 0 to 100,000, wherein the sum of a, b, c, and d, and of e, f, g and h, is in each case at least 1. Preferred radicals R^{x} and R^{y} are hydrogen, methyl, ethyl, propyl, phenyl, and chlorine radicals, with methyl most preferred. Examples of polysiloxanes are polydimethylsiloxane and aminopolydimethylsiloxane.

The polymers employed usually have an average molar mass within a range from 1000-2,000,000 g/mol. Polyvinyl chloride usually has an average molar mass within a range from 20,000-1,000,000 g/mol, poly(meth)acrylates usually have an average molar mass within a range from 15,000-2,000,000 g/mol, polysiloxanes and polysilanes usually have an average molar mass within a range from 1000-500,000 g/mol, polystyrene usually has an average molar mass within a range from 8000-2,000,000 g/mol, polypropylene glycol usually has an average molar mass within a range from 4000-30,000 g/mol, polyvinyl alcohol and polyvinyl acetate usually have an average molar mass within a range from 1000-100,000 g/mol.

There are generally no restrictions on the chromatography columns. The chromatography columns used may be any columns known to those skilled in the art for liquid chromatography, in particular commercially available columns, that is to say SEC columns, HPLC columns, and IC columns. SEC columns and HPLC columns are preferred, and HPLC columns particularly preferred.

The mobile phase used for the liquid chromatography analysis comprises a mixture of at least one solvent (S2) and at least one nonsolvent (S1) for the polymer sample. Non-solvents are understood as meaning all liquids in which the solubility of a polymer sample is lower than in the solvent. Those skilled in the art can establish from the specialist literature (e.g. Polymer Data Handbook, 2nd edition, 2009, Oxford University Press) which liquids can be used in each case as solvents or nonsolvents for which polymer or which polymer mixture.

Solvents and nonsolvents may, for example, be independently selected from the group consisting of tetrahydrofuran (THF), toluene, cyclohexane, diethyl ether, tetrachloromethane, dichloromethane, chloroform, 1,4-dioxane, N,N-dimethylacetamide, N,N-dimethylformamide, benzyl alcohol, methyl ethyl ketone, ethyl acetate, acetone, acetonitrile, dimethyl sulfoxide, hexafluoroisopropanol, 2-propanol, methanol, water, and mixtures thereof. Solvents and nonsolvents are preferably independently selected from the group consisting of THF, hexafluoroisopropanol, methanol, acetone, water, and mixtures thereof.

For the purposes of the present invention, S1 denotes the nonsolvent and S2 denotes the solvent. At the start of elution, a mixture is used in which S2 has a certain proportion in vol %, this proportion being referred to as the starting proportion (SP). At the start of elution, a S1:S2 mixture of 100:0 vol % is usually used.

The analysis method according to the invention can be carried out in more than one dimension and can therefore be referred to as n-dimensional, with the number of dimensions relating to the number of liquid components used in the mobile phase.

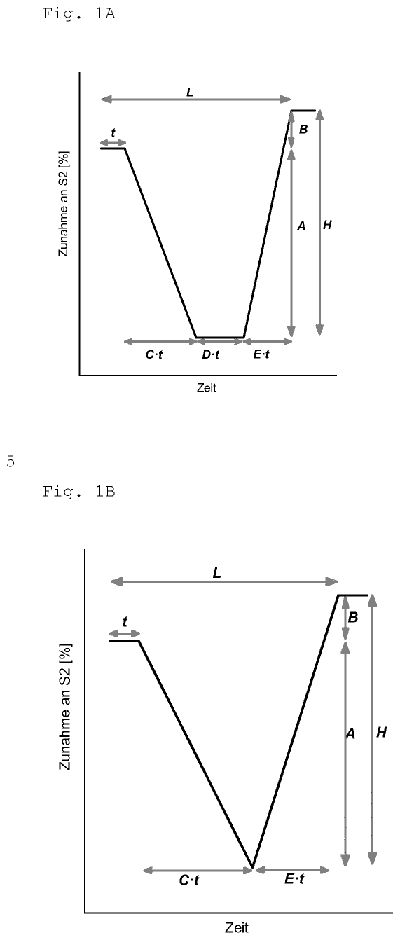

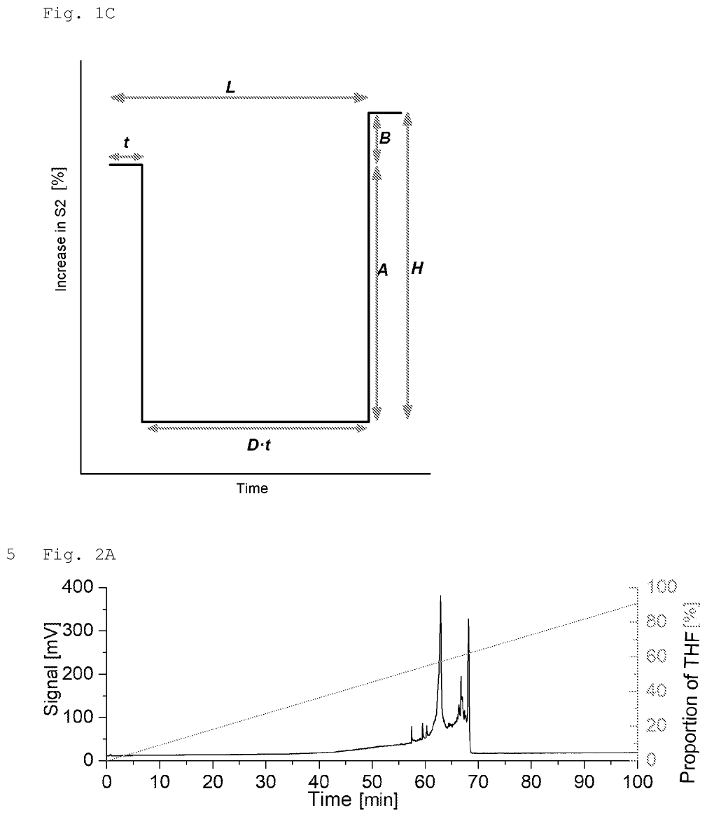

The proportion by volume of S2 is varied in a stepwise manner, with the steps alternately ascending and descending (cf. FIG. 1).

The form of the steps can be selected as desired by those skilled in the art by altering various parameters of those described below.

To describe the steps, a time segment t is calculated from the column volume t′ (Formulas 1 and 2) on which the gradient is based. In general, t′ can be freely selected within a range from 0.1 mL to 1.2 mL.

$$\begin{matrix}{t}^{′} ≅ \frac{Column length [ mm ] \cdot Column {diameter [ mm ]}^{2}}{2000} & ( 1 ) \\ t = \frac{{t}^{′}}{F} & ( 2 )\end{matrix}$$

TABLE 1
Definition of parameters

| | |
|---|---|
| t′ | Column volume [mL] |
| t | Effective column volume [min] |
| F | LC flow rate [mL/min] |
| L | Effective step length [min] |
| Lₜₒₜ | Overall length of sawtooth gradient [min] |
| A | Negative slope [vol % of S2] |
| B | Effective step height [vol % of S2] |
| C | Delay of negative slope (factor] |
| D | Duration of lower plateau [factor] |
| E | Delay of positive slope (factor] |
| H | Total sawtooth height [vol % of S2] |

Via the parameters A, B, C, D, and E it is possible to define steps in columnar, trapezoidal, zigzag or “sawtooth” form (cf. FIGS. 1A-C).

In a particular embodiment (2-dimensional), the mobile phase consists of a nonsolvent S1 and a solvent S2 and the composition of the mobile phase is varied over time as follows,

| | | | Proportion of S2 |
|---|---|---|---|
| Step | Time | Proportion of S1 | generally |
| Step x | t | 100 − S2 | SP + (x − 1)*B |
| | C · t | 100 − S2 | SP + (x − 1)*B − A |
| | D · t | 100 − S2 | SP + (x − 1)*B − A |
| | E · t | 100 − S2 | SP + x*B |

where the parameters A, B, C, D, and E can be freely selected from the following ranges A: 0.01-100% vol % of S2 and B: 0.01-100% vol % of S2 and C: 0-100 and D: 0-100 and E: 0-100.

The composition of the mobile phase is calculated using the following formulas (3-5), which describe the 2-dimensional sawtooth gradient (cf. FIG. 1 and Table 2):

$$\begin{matrix}L = t + C \cdot t + D \cdot t + E \cdot t & ( 3 ) \\ {L}_{tot} = L \cdot \frac{100 \% S 2}{B} & ( 4 ) \\ H = A + B & ( 5 )\end{matrix}$$

Each step x begins with a time segment t, for the duration of which the proportion of S2 is kept at the “starting proportion” (SPₙ) for the respective step, SPₙ=SP+(x−1)*B.

During the subsequent time segment C·t, the proportion of S2 is reduced by the proportion A (e.g. 6% by volume) and is thus (SP+(x−1)*B−A).

During the subsequent time segment D·t, these proportions are kept constant.

During the subsequent time segment E·t, the starting proportion of S2 is increased by the proportion B (e.g. 0.2% vol %) and is thus (SP+x*B). These proportions correspond to the end values of the respective step and at the same time to the starting proportion for the next step. The next step then commences. The proportion of S1 is in each case (100−S2) vol %.

For several steps, negative values are initially calculated for the proportion of S2 because of the descending steps. However, such negative values are mathematically impossible and are therefore set at the level of the starting proportion of S2 until a positive value for S2 is calculated.

Table 2 shows this change in composition again as a mathematical example for the first two steps. This calculation is continued accordingly up to the final step, in which a proportion of S2 of 100 vol % is reached.

The number of steps required can be calculated from Formula 4.

TABLE 2
Change in the composition of the mobile phase over
time for the 2-dimensional sawtooth gradient

| | | Proportion of S2 | |
|---|---|---|---|
| Step | Time | generally | Proportion of S1 |
| Step 1 | t | SP + (x − 1)B | 100 − S2 |
| (x = 1) | C · t | SP + (x − 1)*B − A | 100 − S2 |
| | D · t | SP + (x − 1)*B − A | 100 − S2 |
| | E · t | SP + x*B | 100 − S2 |
| Step 2 | t | SP + (x − 1)*B | 100 − S2 |
| (x = 2) | C · t | SP + (x − 1)*B − A | 100 − S2 |
| | D · t | SP + (x − 1)*B − A | 100 − S2 |
| | E · t | SP + x*B | 100 − S2 |
| Step 3 | t | SP + (x − 1)*B | 100 − S2 |
| (x = 3) | | | |

TABLE 3
Example calculation of the proportion of S2 for A = 6 vol %, B =
0.2 vol %, C = 1, D = 3, E = 1

| | | | Example | Example |
|---|---|---|---|---|
| Step | Time | Time | calculation a | calculation b |
| Step 1 | t | 0.1 | 0 | 7.0 |
| | C · t | 0.2 | 0 | 1.0 |
| | D · t | 0.5 | 0 | 1.0 |
| | E · t | 0.6 | 0.2 | 7.2 |
| Step 2 | t | 0.7 | 0.2 | 7.2 |
| | C · t | 0.8 | 0 | 1.2 |
| | D · t | 1.1 | 0 | 1.2 |
| | E · t | 1.2 | 0.4 | 7.4 |
| Step 3 | t | 1.3 | 0.4 | 7.4 |

When using a 2-dimensional sawtooth gradient, the liquid components are preferably THF and methanol.

In a further realization of this embodiment, the method is repeated at least once, in each case with a different mobile phase, by in each case using the previous solvent as the nonsolvent and selecting a new solvent.

This special method is particularly suitable for the analysis of polymer mixtures. The nonsolvent chosen in each case is one that is suitable as a solvent for at least part of the polymers in the polymer mixture. This achieves separation of the polymer mixture into the individual polymers through the varying solubility of the polymers in the various mobile phases. For example, in the first passage, methanol is thus used as the nonsolvent and acetone as the solvent, in the second passage, acetone is used as the nonsolvent and THF is used as the solvent. This process is a special case of the 2-dimensional gradient.

In a further particular embodiment (3-dimensional), the mobile phase consists of two nonsolvents S1 and S1′ and a solvent (S2) and the composition of the mobile phase is varied over time as follows,

| | | Proportion | Proportion | Proportion |
|---|---|---|---|---|
| Step | Time | of S1 | of S2 | of S1′ |
| Step x | t | 0 | SP + (x − 1)*B | 100 − S2 |
| | C · t | 100 − S2 | SP + (x − 1)*B − A | 0 |
| | D · t | 100 − S2 | SP + (x − 1)*B − A | 0 |
| | 0.01 | 0 | SP + (x − 1)*B − A | 100 − S2 |
| | t | 0 | SP + (x − 1)*B − A | 100 − S2 |
| | E · t | 0 | SP + x*B | 100 − S2 |

where the parameters A, B, C, D, and E can be freely selected from the following ranges A: 0.01-100% vol % of S2 and B: 0.01-100% vol % of S2 and C: 0-100 and D: 0-100 and E: 0-100.

The change in the composition of the mobile phase is calculated using the following formulas (6) and (7), which describe the 3-dimensional sawtooth gradient (cf. Table 4):

$$\begin{matrix}{L}^{3 D} = t + C \cdot T + D \cdot t + 0.01 + t + E \cdot t & ( 6 ) \\ {L}_{tot} = L \cdot \frac{100 \% S 2}{B} & ( 7 )\end{matrix}$$

Each step x begins with a time segment t, for the duration of which the proportion of S1, S2, and S1′ is kept at the “starting proportion” (SPₙ) for the respective step, SPₙ=SP+(x−1)*B. In step 1, the proportion of S2 corresponds to the starting proportion SP.

During the subsequent time segment C·t, the proportion of S2 is reduced by A to (SP+(x−1)*B−A). The proportion of S1 is (100−S2) vol %. The proportion of component S1′ is 0 vol %.

During the subsequent time segment D·t, the previous proportions of S1, S2, and S1′ are kept constant.

During the subsequent time segment, S2 is further kept constant for 0.01 seconds. However, the proportion of S1′ is now (100−S2) vol % and the proportion of S1 is 0 vol %.

During the subsequent time segment t, the previous proportions of S1, S2, and S1′ are kept constant.

During the subsequent time segment E·t, the starting proportion of S2 is increased by the proportion B (e.g. 0.2% vol %) to (SP+x*B). The proportion of S1′ is now (100−S2) vol % and the proportion of S1 remains 0 vol %.

These proportions correspond to the end values of the respective step and at the same time to the “starting proportion” for the next step.

The next step then commences.

For several steps, negative values are initially calculated for the proportion of S2 because of the descending steps. However, such negative values are mathematically impossible and are therefore set at the level of the starting proportion SP of S2 until a positive value for S2 is calculated.

Table 4 shows these changes in composition again as a mathematical example for the first two steps. This calculation is continued accordingly up to the final step, in which a proportion of S2 of 100 vol % is reached.

The number of steps required can be calculated from Formula 7.

TABLE 4
Change in the composition of the mobile phase over
time for the 3-dimensional sawtooth gradient

| | | Proportion | Proportion | Proportion |
|---|---|---|---|---|
| Step | Time | of S1 | of S2 | of S1′ |
| Step 1 | t | 0 | SP + (x − 1)*B | 100 − S2 |
| (x = 1) | C · t | 100 − S2 | SP + (x − 1)*B − A | 0 |
| | D · t | 100 − S2 | SP + (x − 1)*B − A | 0 |
| | 0.01 | 0 | SP + (x − 1)*B − A | 100 − S2 |
| | t | 0 | SP + (x − 1)*B − A | 100 − S2 |
| | E · t | 0 | SP + x*B | 100 − S2 |
| Step 2 | t | 0 | SP + (x − 1)*B | 100 − S2 |
| (x = 2) | C · t | 100 − S2 | SP + (x − 1)*B − A | 0 |
| | D · t | 100 − S2 | SP + (x − 1)*B − A | 0 |
| | 0.01 | 0 | SP + (x − 1)*B − A | 100 − S2 |
| | t | 0 | SP + (x − 1)*B − A | 100 − S2 |
| | E · t | 0 | SP + x*B | 100 − S2 |
| Step 3 | t | 0 | SP + (x − 1)*B | 100 − S2 |
| (x = 3) | | | | |

The parameters A, B, C, D, and E can generally be freely selected from the following ranges

A: 0.01-100% vol % of S2

and B: 0.01-100% vol % of S2

and C: 0-100.

and D: 0-100.

and E: 0-100.

The sole limitation here is potentially the technical details of the LC instrument and of the pump. The values C, D, and E are preferably greater than 0.

The parameters A, B, C, D, and E are preferably selected from the following ranges

A: 3.0-12.0% vol % of S2

and B: 0.2-1.0% vol % of S2

and C: 0.5-3.0

and D: 0.5-3.0

and E: 0.1-2.0.

The parameters A, B, C, D, and E particularly preferably have the following values: A: 6.0 vol % and B: 0.2 vol % and C: 1.0 and D: 3.0 and E: 2.0.

### EXAMPLES

Materials Used:
HPLC: 1) Thermo Fisher Scientific Ultimate 3000 with binary pump
   2) Thermo Fisher Scientific Ultimate 3000 with quaternary pump
   3) Thermo Fisher Scientific Vanquish UHPLC with diode array detector HL (detection wavelength 215 nm)
Detector: Agilent 385 ELSD
Column 1: Poroshell C18, 50×4.6 mm, 2.7 μm (Agilent)
Column 2: Poroshell C18, 100×4.6 mm, 2.7 μm (Agilent)
Column 3: Hypersil BDS C18, 100×4.6 mm, 2.4 μm (Thermo Fisher)
Column 4: Luna C18, 100×4.6 mm, 5 μm (Phenomenex)
Column 5: Hypersil Gold C18 aQ, 100×10 mm, 5 μm (Thermo Fisher)
Column 6: Accucore C18, 50×4.6 mm, 2.6 μm (Thermo Fisher)
Column 7: Poroshell HILIC, 50×4.6 mm, 2.7 μm (Agilent)

The following were used for the mobile phase:

Tetrahydrofuran (not stabilized, HPLC grade, Merck Darmstadt), methanol (HPLC grade, Merck Darmstadt), and ultrapure water (conductivity 18.5 MOhm·cm, TOC<4 ppb).

TABLE 5
Overview of the polymer standards used

| | | Molar mass Mₚ | |
|---|---|---|---|
| Manufacturer | Polymer | [g/mol] | Polydispersity |
| Polymer | PS 8995 | 8995 | 1.03 |
| Laboratories | PVC 23,900 | 23,900 | 1.21 |
| | PVC 45,400 | 45,400 | 1.30 |
| | PVC 92,100 | 92,100 | 1.32 |
| | PVC 202,00 | 202,000 | 1.34 |
| Wacker Chemie | PDMS 1300 | 1300 | 1.34 |
| AG | PDMS 2000 | 2000 | 1.42 |
| | PDMS 5400 | 5400 | 1.67 |
| | PDMS 8300 | 8300 | 1.83 |
| | PDMS 20,700 | 20,700 | 3.02 |
| | PDMS 36,500 | 36,500 | 2.98 |
| | PDMS 71,200 | 71,200 | 4.35 |
| | PDMS 130,000 | 130,000 | 6.09 |
| | PDMS 250,000 | 250,000 | 10.94 |
| Polymer | PMMA 19,700 | 19,700 | 1.09 |
| Laboratories | PMMA 107,000 | 107,000 | 1.1 |
| | PMMA 690,000 | 690,000 | 1.09 |
| | PMMA 1,600,000 | 1,600,000 | 1.33 |
| American | PPG 4850 | 4850 | 1.10 |
| Polymer | PPG 13,300 | 13,300 | 1.14 |
| Standards | PPG 19,600 | 19,600 | 1.25 |
| | PPG 27,100 | 27,100 | 1.61 |

Preliminary Tests for Parameter Optimization

The test analyte used is polystyrene (Mp=19,600 g/mol, polydispersity 1.03 from PSS Polymer Standard Services, Mainz). Polystyrene is dissolved in THF at a concentration of c=25 mg/ml, the injection volume is 5 pal. The analysis takes place on HPLC instrument 2.

The parameters for optimizing the sawtooth gradient are modified based on Taguchi's L16 (4⁵) test plan design (“The Taguchi Approach to Parameter Design”, 1986, ASQC Conference Proceedings; “Taguchi's quality engineering handbook”, 2011, John Wiley & Sons), see Table 2.

The optimized target variables were (1) the number of separated peaks, (2) the resolution, (3) the asymmetry, and (4) the peak width at half height. The variation in the parameters is shown in Table 2. In addition, the test series was carried out on five different commercially available chromatography columns.

The number of peaks and thus the quality of the polymer resolution was found to be primarily a consequence of parameter B. The other target variables showed less influence by comparison.

The optimized parameters are shown in Table 6 for each column. The optimal values for parameters A-E were found to be quite similar and therefore not dependent on the column. A generally applicable optimum is therefore assumed (cf. final row in Table 6).

TABLE 6
Parameters for optimization of the sawtooth gradient

| Label | Parameter | Level 1 | Level 2 | Level 3 | Level 4 |
|---|---|---|---|---|---|
| A | Negative | 3.0 | 6.0 | 9.0 | 12.0 |
| | slope [%] | | | | |
| B | Effective | 0.2 | 0.5 | 0.8 | 1.0 |
| | step height | | | | |
| | [%] | | | | |
| C | Delay of | 0.5 | 1.0 | 2.0 | 3.0 |
| | negative | | | | |
| | slope | | | | |
| D | Lower plateau | 0.5 | 1.0 | 2.0 | 3.0 |
| E | Delay of | 0.1 | 0.5 | 1.0 | 2.0 |
| | positive | | | | |
| | slope | | | | |

TABLE 7
Test plan confirmatory experiments for optimization

| Column | A [%] | B [%] | C | D | E |
|---|---|---|---|---|---|
| 1 | 6.0 | 0.2 | 1.0 | 3.0 | 2.0 |
| 2 | 6.0 | 0.2 | 0.5 | 2.0 | 2.0 |
| 3 | 6.0 | 0.2 | 1.0 | 3.0 | 2.0 |
| 4 | 6.0 | 0.2 | 1.0 | 3.0 | 2.0 |
| 5 | 6.0 | 0.2 | 0.5 | 0.5 | 2.0 |
| Optimum | 6.0 | 0.2 | 1.0 | 3.0 | 2.0 |

### Example 1

With regard to the total run time, the effective step height B is also of critical importance. The more steps that are executed, the better the resolution, but the longer the total measurement time also. If the measurement time is to be shortened at the smallest effective step height, the effective step length needs to be considered. Because this variable is made up of the individual, firmly defined substeps that, on account of the accuracy of the gradient mixer of the pump used, cannot be shortened any further, another option must be found. Another critical parameter that is included in the calculation of the effective step length is the LC flow.

HPLC instrument 1 with column 6

Concentration of polymer: 90 mg/ml PDMS with Mp=36,500 g/mol

Injection volume: 5 μl

Flow rate: 1 ml/min, 2 ml/min, 3 ml/min

t=0.1 min

A=6 vol %

B=0.2 vol %

C=1

D=3

E=1

L=0.2 min/0.3 min/0.6 min

H=6.2 vol %

It was found that increasing the flow rate from 1 mL/min to 3 mL/min can reduce the measurement time by a factor of 3 without adversely affecting the resolution.

### Example 2

Linear gradient, step gradient with exclusively increasing steps, and sawtooth gradient are compared, with PVC 45,500 serving as the test analyte (PVC 45,500 g/mol, Polymer Laboratories).

HPLC instrument 1 with column 6

Concentration of polymer: 100 mg/ml

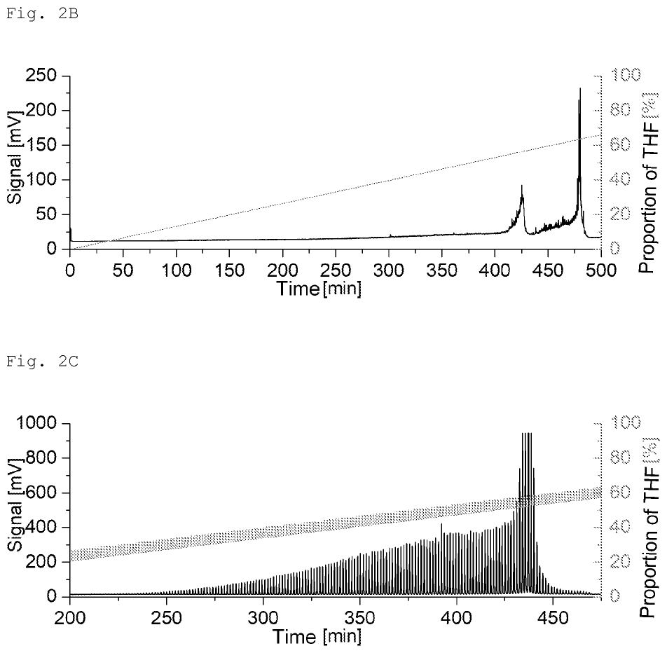

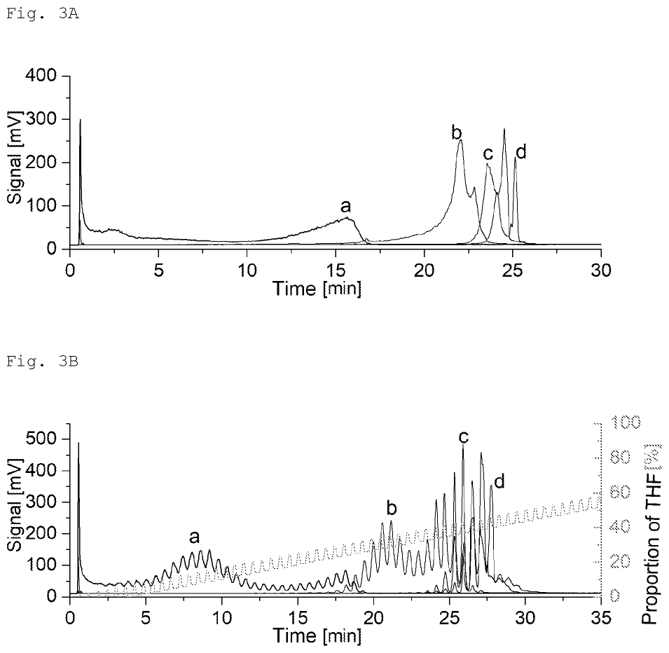

Injection volume: 1 μL (FIGS. 2A and 2B), 3 μl (FIG. 2C)

Flow rate: 1 ml/min

Start condition 0% THF/100% methanol, end condition 100% THF/0% methanol (for all gradients)

t=0.1 min

A=6 vol %

B=0.2% vol % (the step gradient and the sawtooth gradient both have an effective step height of 0.2% vol %)

C=1

D=3

E=1

L=1.5 min

H=6.2 vol %

The resolution of the sawtooth gradient is significantly improved by comparison with the other analysis techniques, which can be seen clearly from the increased number of peaks (cf. FIG. 2).

### Example 3

Linear gradient and sawtooth gradient are compared in different polymers on different columns; the test conditions are shown in Table 8.

HPLC instrument 1 with column 6 or column 7

Concentration of polymer: 15 mg/ml

Injection volume: 4 μl

Flow rate: 1 ml/min

t=0.25 min

A=6 vol %

B=1 vol %

C=1

D=3

E=1

L=0.6 min

H=7 vol %

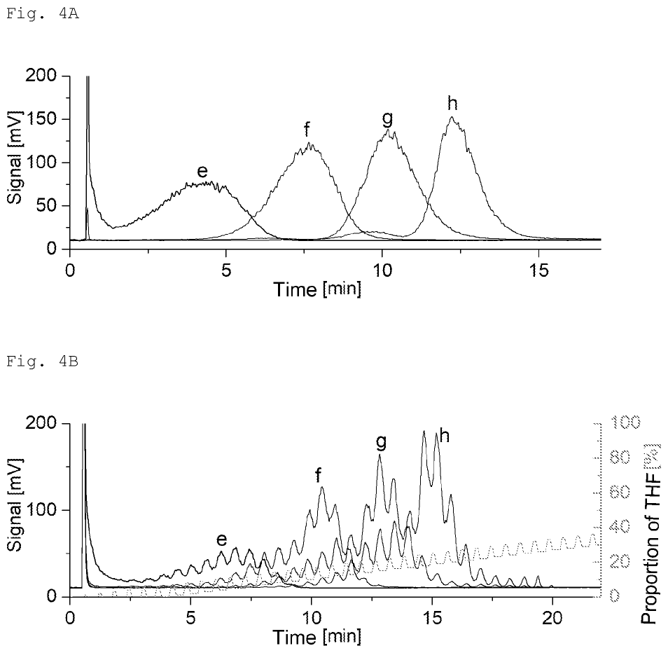

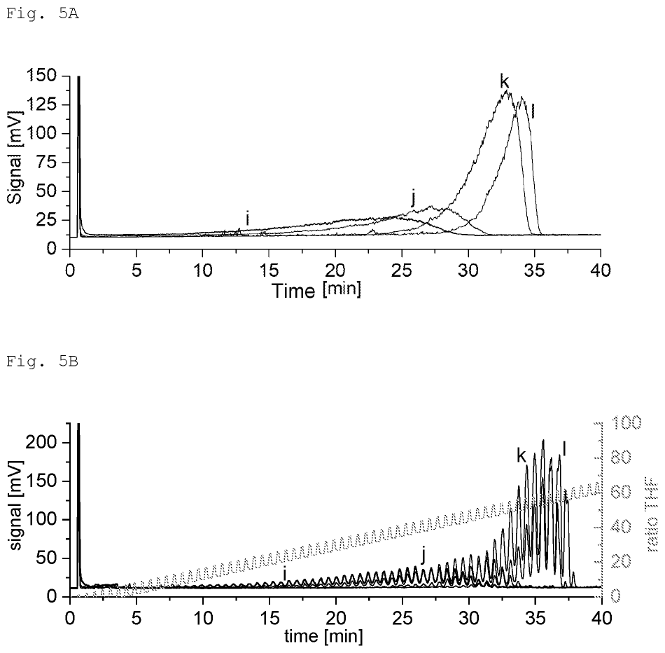

TABLE 8
Test conditions for Example 3

| | Assignments in | |
|---|---|---|
| Polymer | FIGS. 3-5 | Column |
| PVC 23,900 | — | Column 6 |
| PVC 45,500 | — | |
| PVC 92,100 | — | |
| PVC 202,000 | — | |
| PMMA 19,700 | a | |
| PMMA 107,000 | b | |
| PMMA 690,000 | c | |
| PMMA 1,600,000 | d | |
| PDMS 20,800 | — | |
| PDMS 36,500 | — | |
| PDMS 130,000 | — | |
| PDMS 250,000 | — | |
| PPG 4850 | e | |
| PPG 13,300 | f | |
| PPG 19,600 | g | |
| PPG 27,100 | h | |
| PVC 23,900 | — | Column 7 |
| PVC 45,400 | — | |
| PVC 92,100 | — | |
| PVC 202,000 | — | |
| PMMA 19,700 | — | |
| PMMA 690,000 | — | |
| PMMA 107,000 | — | |
| PMMA 1,600,000 | — | |
| PDMS 20,700 | i | |
| PDMS 36,500 | j | |
| PDMS 130,000 | k | |
| PDMS 250,000 | l | |

For all polymers, the resolution shows clear improvement when using the sawtooth gradient, this being manifested in an increased number of peaks and improved peak shape. This is shown by way of example for PMMA and PPG on column 6 and for PDMS on column 7 (cf. FIGS. 3-5).

### Example 4

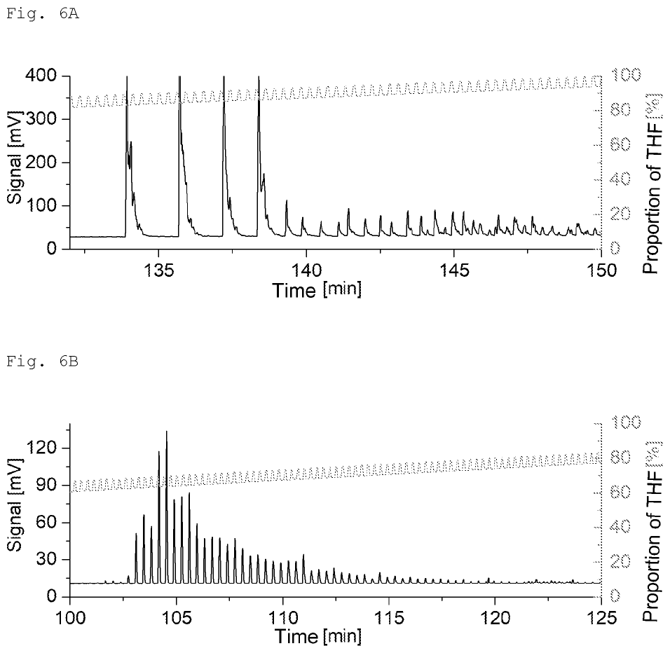

An HPLC analysis with 3-dimensional sawtooth gradients is carried out for separation of PMMA 690,000. The change in the composition of the mobile phase takes place as described previously for the 3-dimensional sawtooth gradient (Table 4). The following liquid components are used: S2=THF, S1=water, S1′=methanol. For comparison, the same analysis is also carried out with a 2-dimensional sawtooth gradient (cf. FIG. 6).

HPLC instrument 2 with column 6

Concentration of polymer: 15 mg/ml

Injection volume: 4 μl

Flow rate: 2 ml/min

t=0.25 min

A=6 vol %

B=1 vol %

C=1

D=3

E=1

L=0.6 min

H=7 vol %

### Example 5

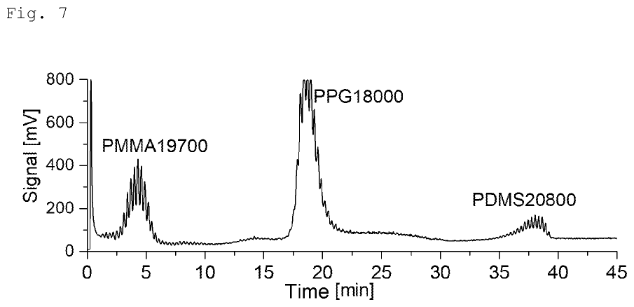

An HPLC analysis to separate 3 polymers (PMMA 19,700, PPG 18,000, PDMS 20,800) with a similar average molar mass (see FIG. 7) is carried out. For this, a 2-dimensional sawtooth gradient is applied twice in succession with a different mobile phase. Sawtooth gradient 1 runs from 100 vol % of methanol (0% vol % of acetone) to 100 vol % of acetone (0 vol % of methanol) in 30 minutes. This is followed by sawtooth gradient 2, which runs from 100 vol % of acetone (0% vol % of THF) to 100 vol % of THF (0 vol % of acetone) likewise in 30 minutes. (Overall run time 60 min).

HPLC instrument 2 with column 6

Concentration of the polymers: in each case 20 mg/mL

Injection volume: 5 μl

Flow rate: 2 ml/min

Parameters:

t=0.25 min

A=6 vol %

B=1 vol %

C=1

D=3

E=1

L=0.6 min

H=7 vol %

Examples 1-5 show that the method according to the invention can be used for a multiplicity of polymers, even those having very large average molar masses, and with a multiplicity of chromatography columns too. The sole prerequisite as regards suitability is that the analyte under investigation shows some degree of retention on the column. This, however, will form part of the general specialist knowledge of those skilled in the art.

1.-13. (canceled)

14. A method for analyzing a polymer sample, the method consisting of performing a liquid chromatography analysis on a chromatography column with a mobile phase comprising a mixture of at least one nonsolvent (S1) and at least one solvent (S2) for the polymer sample, wherein the proportion by volume of S2 in the mobile phase is varied in a stepwise manner during the elution process and that the steps are alternately ascending and descending, wherein either
a) the mobile phase consists of a nonsolvent S1 and a solvent S2 and the composition of the mobile phase is varied over time as follows, with regard to step, time, proportion of S1 and proportion of S2, respectively:

| | | | |
|---|---|---|---|
| Step x: | t | 100 − S2 | SP + (x − 1)*B |
| | C · t | 100 − S2 | SP + (x − 1)*B − A |
| | D · t | 100 − S2 | SP + (x − 1)*B − A |
| | E · t | 100 − S2 | SP + x*B |

where the parameters A, B, C, D, and E are selected from the following ranges A: 0.01-100% vol % of S2 and B: 0.01-100% vol % of S2 and C: 0-100 and D: 0-100 and E: 0-100; or
b) the mobile phase consists of two nonsolvents S1 and S1′ and a solvent S2 and the composition of the mobile phase is varied over time as follows, with regard to step, time, proportion of S1, proportion of S2, and proportion of S1, respectively:

| | | | | |
|---|---|---|---|---|
| Step x: | t | 0 | SP + (x − 1)*B | 100 − S2 |
| | C · t | 100 − S2 | SP + (x − 1)*B − A | 0 |
| | D · t | 100 − S2 | SP + (x − 1)*B − A | 0 |
| | 0.01 | 0 | SP + (x − 1)*B − A | 100 − S2 |
| | t | 0 | SP + (x − 1)*B − A | 100 − S2 |
| | E · t | 0 | SP + x*B | 100 − S2 |

where the parameters A, B, C, D, and E are selected from the following ranges A: 0.01-100% vol % of S2 and B: 0.01-100% vol % of S2 and C: 0-100 and D: 0-100 and E: 0-100.

15. The method of claim 14, wherein the shapes of the steps are columnar, trapezoidal, zigzag or sawtooth in form.

16. The method of claim 14, wherein the polymer sample is a single polymer.

17. The method of claim 16, wherein the polymer sample is a polymer selected from the group consisting of polyvinyl chloride, polyethylene, polypropylene, polyvinyl acetate, polycarbonate, poly(meth)acrylate, polystyrene, polyacrylonitrile, polyvinylidene chloride, polyvinyl fluoride, polyvinylidene fluoride, polyvinylidene cyanide, polybutadiene, polyisoprene, polyethers, polyesters, polyamide, polyimide, polysiloxanes, polysilanes, polyvinyl alcohol, polyvinylpyrrolidone, polyacrylamide, polyethylene glycol, and derivatives and copolymers thereof, cellulose, starch, casein, and natural rubber, methylcellulose, hydroxymethyl cellulose, and carboxymethyl cellulose.

18. The method of claim 14, wherein the polymer sample is a polymer mixture.

19. The method of claim 18, wherein the polymer sample is a polymer mixture comprising at least two polymers from the group consisting of polyvinyl chloride, polyethylene, polypropylene, polyvinyl acetate, polycarbonate, poly(meth)acrylate, polystyrene, polyacrylonitrile, polyvinylidene chloride, polyvinyl fluoride, polyvinylidene fluoride, polyvinylidene cyanide, polybutadiene, polyisoprene, polyethers, polyesters, polyamide, polyimide, polysiloxanes, polysilanes, polyvinyl alcohol, polyvinylpyrrolidone, polyacrylamide, polyethylene glycol, and derivatives and copolymers thereof, cellulose, starch, casein, natural rubber, methylcellulose, hydroxymethyl cellulose, and carboxymethyl cellulose.

20. The method of claim 14, wherein the method in alternative a) is repeated at least once, in each case with a different mobile phase, by using the previous solvent as the nonsolvent and selecting a new solvent.

21. The method of claim 14, wherein the solvent and nonsolvent are independently selected from the group consisting of THF, toluene, cyclohexane, diethyl ether, tetrachloromethane, dichloromethane, chloroform, 1,4-dioxane, N,N-dimethylacetamide, N,N-dimethylformamide, benzyl alcohol, methyl ethyl ketone, ethyl acetate, acetone, acetonitrile, dimethyl sulfoxide, hexafluoroisopropanol, 2-propanol, methanol, water, and mixtures thereof.

22. The method of claim 21, wherein solvents and nonsolvents are preferably independently selected from the group consisting of THF, hexafluoroisopropanol, methanol, acetone, water, and mixtures thereof.

23. The method of claim 14, wherein the parameters A, B, C, D, and E are selected from the following ranges:
A: 3.0-12.0% vol % of S2,
B: 0.2-1.0% vol % of S2,
C: 0.5-3.0,
D: 0.5-3.0, and
E: 0.1-2.0.

24. The method of claim 23, wherein the parameters A, B, C, D, and E have the following values: A: 6.0 vol % and B: 0.2 vol % and C: 1.0 and D: 3.0 and E: 2.0.
